(19) United States
(12) Patent Application Publication
(10) Pub. No.: US 2012/0037071 A1
(43) Pub. Date: Feb. 16, 2012

(54) LIQUID-EJECTING APPARATUS

(75) Inventor: Shohei SHIONO, Matsumoto-shi (JP)

(73) Assignee: SEIKO EPSON CORPORATION

(21) Appl. No.: 13/196,943

(22) Filed: Aug. 3, 2011

(30) Foreign Application Priority Data
Aug. 11, 2010 (JP) 2010-180112

(51) Int. Cl. B05C 11/00

(52) U.S. Cl. 118/695

(57) ABSTRACT

A liquid-ejecting apparatus includes a liquid container that contains a liquid containing a substance that can settles, and a vessel that is connected to the liquid container with a tube and receives the liquid from the liquid container. An ejecting head is connected to the vessel. The ejecting head receives the liquid from the vessel and ejects the liquid. The liquid-ejecting apparatus includes also an agitation unit that agitates the liquid in the vessel, and a control unit that controls a first operation that ejects the liquid from the ejecting head and a second operation that causes the agitation unit to agitate the liquid after the first operation.

Priority is claimed under 35 U.S.C. §119 to Japanese Application No. 2010-176371 filed on Aug. 11, 2010, which is hereby incorporated by reference in its entirety.

### BACKGROUND

1. Technical Field

The present invention relates to a liquid-ejecting apparatus.

2. Related Art

Ink supply systems have been known which supply an ink contained in an ink reservoir to an ink-ejecting head through an ink supply tube. In the use of this type of ink supply system, if a long time elapses without ink supply after an ink has been supplied to the ejecting head, a component in the ink remaining in the flow channel of the supply tube may settle. Once an ink component has settled, further ink supply to the ejecting head may become impossible.

In particular, if an ink containing an inorganic pigment, such as titanium oxide, or a metal pigment, such as aluminum, the pigment is liable to settle because of the difference in specific gravity of the pigment from the solvent.

To solve this issue, for example, JP-A-2006-272648 discloses an ink supply system including a sub-reservoir that allows the ink flow channel to hold a constant amount of ink. Also, this patent document discloses that the sub-reservoir is provided with an agitation ball therein to agitate the ink. Such a sub-reservoir can reduce the possibility of the sedimentation of ink components, such as a pigment.

However, if the operation of this ink supply system is suspended for a long time, the pigment will settle in an ink supply tube connecting the ink container and the sub-reservoir, so that the concentration of the ink in the ink supply tube cannot be recovered in spite of the presence of the sub-reservoir.

### SUMMARY

Accordingly, an advantage of some aspects of the invention is that it provides a liquid-ejecting apparatus that can solve the above issue to ensure that the liquid is in good condition in the ink supply tube.

The following embodiments can solve at least part of the issue described above.

According to an aspect of the invention, a liquid-ejecting apparatus is provided which includes a liquid container that contains a liquid containing a component that can settles, and a vessel that is connected to the liquid container with a tube and receives the liquid from the liquid container. An ejecting head is connected to the vessel. The ejecting head receives the liquid from the vessel and ejects the liquid. The liquid-ejecting apparatus includes also an agitation unit that agitates the liquid in the vessel, and a control unit that controls a first operation that ejects the liquid from the ejecting head and a second operation that agitates the liquid with the agitation unit. The second operation is performed after the first operation.

In this apparatus, the liquid in the tube can be replaced with a proper liquid delivered from the liquid container. In addition, since the liquid in the vessel is then agitated, the liquid in the tube and further in the vessel is recovered to a proper concentration.

According to another aspect of the invention, a liquid-ejecting apparatus is provided which includes a liquid container that contains a liquid containing a component that can settle, and a vessel that is connected to the liquid container with a tube and receives the liquid from the liquid container. An ejecting head is connected to the vessel. The ejecting head receives the liquid from the vessel and ejects the liquid to an ejection target medium. The liquid-ejecting apparatus includes also an agitation unit that agitates the liquid in the vessel, and a control unit that controls a first operation that ejects the liquid from the ejecting head to something other than the ejection target medium, a second operation that agitates the liquid in the vessel with the agitation unit, and a third operation that ejects the liquid to the ejection target medium. An evaluation device is also provided to evaluate whether or not the elapsed time after the completion of any of the first operation, the second operation after the first operation, and the third operation is equal to or more than a first threshold time. When the elapsed time is equal to or more than the first threshold time, the control unit causes the first operation to be performed.

According to this embodiment, when the elapsed time is equal to or more than the first threshold time, the liquid in the tube is replaced with a liquid having a proper concentration. Thus, it can be ensured that the liquid in the tube is in good condition. The first threshold time may be the time needed for a component of the liquid to settle completely in the vessel and the tube.

According to still another aspect of the invention, a liquid-ejecting apparatus is provided which includes a liquid container that contains a liquid containing a component that can settle, and a vessel that is connected to the liquid container with a tube and receives the liquid from the liquid container. An ejecting head is connected to the vessel. The ejecting head receives the liquid from the vessel and ejects the liquid to an ejection target medium. The liquid-ejecting apparatus includes also an agitation unit that agitates the liquid in the vessel, and a control unit that controls a first operation that ejects the liquid from the ejecting head to something other than the ejection target medium, a second operation that agitates the liquid in the vessel with the agitation unit, and a third operation that ejects the liquid to the ejection target medium. An input device is also provided so that an operator can input a specific command to the liquid-ejecting apparatus therewith. In addition, an evaluation device is provided to evaluate whether or not the elapsed time from the completion of any of the first operation, the second operation after the first operation, and the third operation until the specific command is inputted with the input device is equal to or more than a first threshold time. When the elapsed time is equal to or more than the first threshold time, the control unit causes the first operation to be performed.

According to this embodiment, the evaluation of the elapsed time is started by the command that the operator input, and when the elapsed time is equal to or more than the first threshold time, liquid in the tube can be replaced with the liquid having a proper concentration from the liquid container. Thus, the liquid in the tube can be recovered to a proper concentration.

When the elapsed time is equal to or more than the first threshold time in the above second embodiment, the control unit may allow the second operation to be further performed after the first operation.

In this instance, since the interior of the vessel is agitated, it can be ensured that the liquid in the vessel as well as the liquid in the tube is in good condition.

When the elapsed time is equal to or more than the first threshold time in the above third embodiment, the control unit may allow the second operation to be further performed after the first operation.

In this instance, since the interior of the vessel is agitated, it can be ensured that the liquid in the vessel as well as the liquid in the tube is in good condition.

In the above first embodiment, the control unit may allow the first operation to be performed again after the second operation.

Thus, the liquid in a tube connecting the vessel and the ejecting head or in the ejecting head can also be replaced with a liquid having a proper concentration.

When the elapsed time is equal to or more than the first threshold time in the above second embodiment, the control unit may allow the second operation to be further performed after the first operation, and then the first operation to be performed again.

Thus, the liquid in a tube connecting the vessel and the ejecting head or in the ejecting head can also be replaced with a liquid having a proper concentration.

When the elapsed time is equal to or more than the first threshold time in the above third embodiment, the control unit may allow the second operation to be further performed after the first operation, and then the first operation to be performed again.

Thus, the liquid in a tube connecting the vessel and the ejecting head or in the ejecting head can also be replaced with a liquid having a proper concentration.

The evaluation device may determine whether or not the elapsed time is equal to or more than a second threshold time longer than the first threshold time, and less than the first threshold time, and when the elapsed time is equal to or more than the second threshold time and less than the first threshold time, the control unit causes the second operation to be performed.

In this instance, the evaluation of the elapsed time can be performed by the command that the operator input, and when the elapsed time is equal to or more than the second threshold time, the liquid in the vessel can be agitated so as to have a proper concentration.

The first threshold time may be a time equal to or more than the time needed for the substance that can settle to settle completely in the vessel and the tube.

In this instance, the substance that can settle has settled before liquid is replaced. Accordingly, the substance in the vessel can be more favorably prevented from being discharged by the first operation.

The control unit may allow the third operation to be performed during the second operation, and when the elapsed time is equal to or more than the first threshold time, the amount of liquid ejected in the first operation is 0.4 times or more and less than 1.0 times the capacity of the tube.

Thus, in the third operation, a liquid having a uniform composition can be ejected while the ejection by the first operation is reduced.

### BRIEF DESCRIPTION OF THE DRAWINGS

The invention will be described with reference to the accompanying drawings, wherein like numbers reference like elements.

FIG. 1 is a schematic perspective view of a liquid agitation unit of a liquid-ejecting apparatus according to an embodiment of the invention.

FIG. 2 is a block diagram of functions of the liquid-ejecting apparatus.

FIG. 3 is a flowchart showing the control in the liquid-ejecting apparatus.

FIGS. 4A to 4C are schematic representations of states of sediment in the liquid agitation unit.

FIG. 5 is a schematic perspective view of an ink jet printer as a liquid-ejecting apparatus according to an embodiment of the invention.

FIG. 6 is a plot of the changes in titanium dioxide concentration in a white ink composition with the amount of the white ink composition ejected.

### DESCRIPTION OF EXEMPLARY EMBODIMENTS

Exemplary embodiments of the invention will now be described, but the invention is not limited to the disclosed embodiments.

### 1. 1. Container

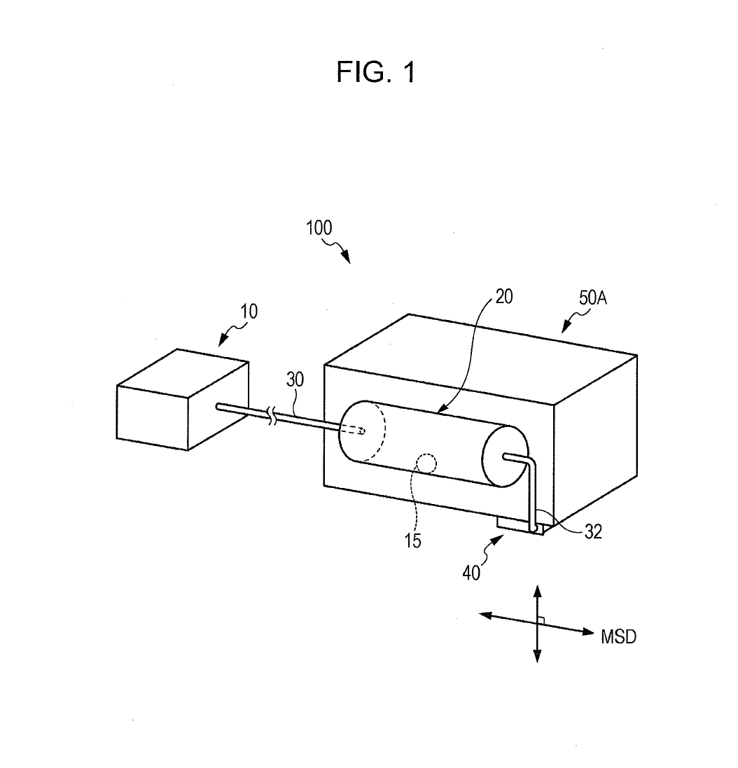

FIG. 1 shows a liquid agitation unit 100 of a liquid-ejecting apparatus according to an embodiment of the invention. The liquid agitation unit 100 includes a container 10. The container 10 contains a liquid having a predetermined concentration. The container 10 communicates with a vessel 20 through a liquid supply tube 30. Thus, liquid can be delivered to the vessel 20.

The liquid mentioned herein contains a substance that can settle, and may be a dispersion, such as suspension or an emulsion. The liquid in the container 10 may be an ink composition, an organic EL display material, a color filter material for liquid crystal displays, a field emission display (FED) material, an electrode or color filter material for electrophoretic displays, or a bioorganic material used for manufacturing bio-chips.

“To settle” means that a component of a liquid is precipitated and falls as sediment when the liquid is allowed to stand for a while. For example, a component having a higher specific gravity than the solvent can settle into sediment. In an ink composition, the sediment may contain an inorganic pigment, a metal pigment, hollow resin particles, or a substance combined with or adsorbed to these ink components.

Examples of such an inorganic pigment include titanium dioxide, silicon oxide, aluminum oxide, zinc oxide, iron oxide, and carbon black. Examples of such a metal pigment include elementary metals, such as aluminum, gold, silver, copper, and titanium, and their alloys. Hollow resin particles may be those disclosed in U.S. Pat. No. 4,880,465 or Japanese Patent No. 3562754. A hollow resin particle refers to a resin particle defined by an outer shell made of a liquid-permeable resin, having a hollow interior. A white pigment may be used as the hollow resin particles.

In the following description, a white ink composition will be described as a representative example of the liquid contained in the container 10. The white ink composition may contain a resin that fixes a pigment. Examples of such a resin include polyvinyl alcohol, polyethylene glycol, polyacrylic acid, polyurethane, polyacrylamide, and cellulose derivatives. Acrylic resins (for example, Almatex produced by Mitsui Chemicals) and urethane resins (for example, WBR-022U produced by Taisei Fine Chemical) are commercially available.

Preferably, the white ink composition further contains a compound selected from the group consisting of alkanediols and glycol ethers. Alkanediols and glycol ethers can increase the wettability of the surface of the ejection target medium to enhance the penetration of the ink.

Preferred alkanediols are 1,2-alkanediols having a carbon number in the range of 4 to 8, such as 1,2-butanediol, 1,2-pentanediol, 1,2-hexanediol, 1,2-heptanediol, and 1,2-octanediol. Among those, 1,2-hexanediol, 1,2-heptane diol, and 1,2-octanediol, which have carbon numbers of 6 to 8 and have high penetration into media, are particularly suitable.

Exemplary glycol ethers include lower alkyl ethers of polyhydric alcohols, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. In particular, the use of triethylene glycol monobutyl ether can result in high quality.

Preferably, the white ink composition further contains an acetylene glycol-based surfactant or a polysiloxane-based surfactant. Acetylene glycol-based and polysiloxane-based surfactants can increase the wettability to the surface of the ejection target medium to enhance the penetration of the ink composition.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, such as OLFINE (registered trademark) E1010, OLFINE STG and OLFINE Y (each produced by Nissin Chemical Industry); and SURFYNOLs (registered trademark) 104, 82, 465, 485 and TG (each produced by Air Products and Chemicals Inc.).

The polysiloxane-based surfactant is commercially available as, for example, BYK-347 or BYK-348 (produced by BYK).

The white ink composition may contain other surfactants, such as an anionic surfactant, a nonionic surfactant, and an amphoteric surfactant.

Preferably, the ink composition contains a polyhydric alcohol. In the use of the white ink composition in, for example, an ink jet recording apparatus, polyhydric alcohols hinder the ink from drying to prevent the ink from clogging the ejecting head.

Exemplary polyhydric alcohols include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane.

Preferably, the ink composition contains water as a solvent. Preferably, the water is pure water or ultrapure water, such as ion exchanged water, ultrafiltered water, reverse osmotic water, or distilled water. More preferably, the water is sterilized, for example, by irradiation with UV light or by adding hydrogen peroxide. Such water prevents occurrence of mold and bacteria over the long term.

The white ink composition may further contain other additives, for example, a fixing agent such as water-soluble rosin, an antifungal agent or preservative such as sodium benzoate, an antioxidant or ultraviolet light adsorbent such as an allophanate, a chelating agent, a pH adjuster such as triethanolamine, and an oxygen absorbent, if necessary. These additives may be used singly or in combination.

### 1. 2. Liquid Supply Tube

The liquid agitation unit 100 of the present embodiment further include a liquid supply tube. In the liquid agitation unit 100 shown in FIG. 1, a first tube 30 corresponding to the liquid supply tube connects the container 10 and the vessel 20. The first tube 30 allows the liquid in the container 10 to flow into the vessel 20. In the vessel 20, an agitation member 15 is placed to agitate the liquid.

The inner diameter of the first tube 30 is such that the agitation member 15 cannot be moved into the first tube 30, and is not otherwise limited. For example, the first tube 30 preferably has an inner diameter in the range of 2 to 5 mm, and more preferably in the range of 2 to 4 mm. Preferably, the capacity of the first tube 30 is smaller than or equal to that of the vessel 20. Thus, the ejecting head 40 can receive a liquid having a constant uniform composition. More specifically, if the first tube 30 has a larger capacity than the vessel 20, the supernatant in the first tube 30 is likely to be delivered to the ejecting head 40 after the replacement operation described below. The capacity of the first tube mentioned herein refers to the volume of the interior of the first tubed through which a liquid is delivered, and the capacity of the vessel 20 refers to the volume of the interior of the vessel 20 to which the liquid is delivered.

The liquid agitation unit 100 may also include a second tube 32 connecting the vessel 20 and the ejecting head 40, as shown in FIG. 1. The liquid contained in the container 10 is delivered to the vessel 20 through the first tube 30, and agitated with the agitation member 15 in the vessel 20. Then, it is supplied to the ejecting head 40 through the second tube 32. The inner diameter of the second tube 32 is the same as that of the first tube 30 and thus description thereof is omitted.

In the liquid agitation unit 100 shown in FIG. 1, the vessel 20 and the ejecting head 40 are connected with the second tube 32 therebetween. However, the vessel 20 and the ejecting head 40 may be directly connected without using the second tube 32.

### 1. 3. Agitation Operation

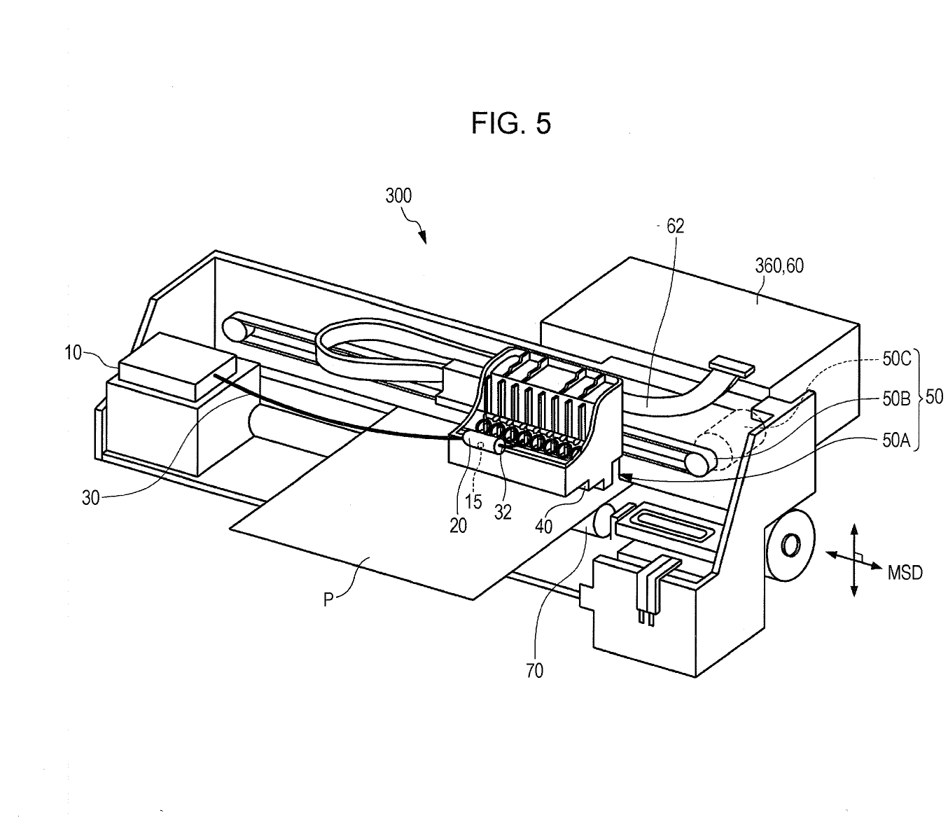

The liquid-ejecting apparatus including the liquid agitation unit 100 performs an agitation operation for agitating the liquid in the vessel 20. In an ink jet printer 300 shown in FIG. 5, for example, a vessel 20 charged with a liquid containing a substance that can settle is mounted on a carriage 50A to constitute a liquid agitation unit. In this structure, the interior of the vessel 20 can be moved and agitated by the transfer mechanism of the carriage 50A without the need for an additional mechanism to transfer the vessel 20. The agitation operation mentioned herein means agitating the liquid in the vessel 20 sufficiently, unlike the slight agitation (described later) performed in the initial operation of the liquid-ejecting apparatus.

In the liquid-ejecting apparatus of the present embodiment, an agitation member 15 may be movably placed within the vessel 20, as shown in FIG. 1. By moving the agitation member 15 within the vessel 20, the liquid can be agitated.

In the present embodiment, the agitation is performed with the agitation member 15 by the reciprocal movement of the carriage 50A. However, the mechanism for agitation is not limited to the above structure. A vessel 20 fixed to a support may be moved back and forth and around, thereby agitating the liquid in the vessel 20. Ultrasonic waves may vibrate the liquid in the vessel 20, thereby agitating the liquid. The vessel 20 may be tilted to move and agitate the liquid. A magnetic material placed in the vessel 20 may be moved by moving a magnet outside the vessel 20, thereby agitating the liquid in the vessel 20. Air may be blown into the vessel 20 with a pump. Such an agitation mechanism can agitate the liquid in the vessel 20 even if the liquid-ejecting apparatus includes a line-type ejecting head.

### 1. 4. Displacement Operation

The liquid-ejecting apparatus performs a replacement operation for replacing the liquid in the vessel 20 without ejecting the liquid onto an ejection target medium. The replacement operation may be performed with, for example, a vacuum pump or a tube pump. For example, the suction of the liquid using a tube pump may be performed by use of the mechanism disclosed in JP-A-2003-165231 (FIG. 13). More specifically, the head is provided with a capping device connected to a tube pump to close the liquid ejection face of the head, and then the liquid is ejected by drawing the air into the tube with pump rollers.

In the liquid-ejecting apparatus of the present embodiment, when the liquid is drawn from the ejecting head 40 with a suction pump or the like, the liquid in the vessel 20 is ejected from the ejecting head 40, and in addition, the liquid in the first tube 30 is delivered into the vessel 20 at the same time. Thus, the liquid in the vessel 20 is replaced with the liquid in the first tube 30. Also, the liquid in the second tube is replaced with the liquid in the vessel 20.

The replacement operation may be performed by flushing, which is a known technique for maintenance of the nozzle apertures of the head 40, performed by ejecting the liquid to a liquid absorption pad. Alternatively, the replacement operation may be performed by another known technique in which the liquid is not ejected to an ejection target medium.

### 1. 5. Ejection Operation

The liquid-ejecting apparatus performs a third operation that ejects the liquid onto an ejection target medium using the ejecting head 40. For ejecting the liquid, any of the known techniques can be applied, such as the piezoelectric ink jet method and the thermal ink jet method.

### 1. 6. Control Unit

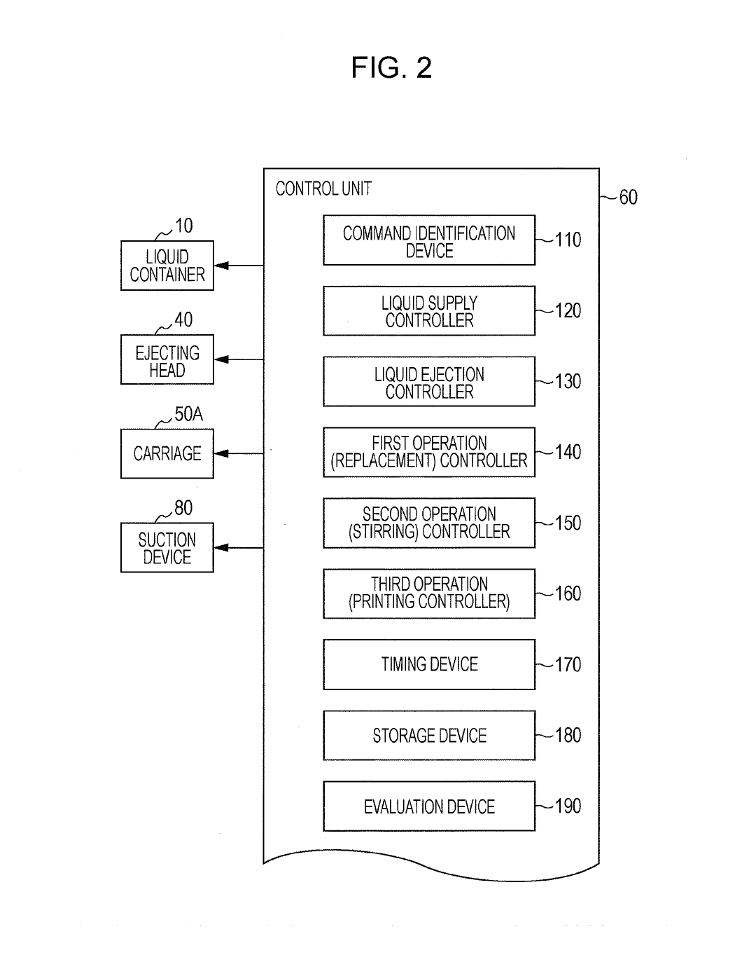

The liquid-ejecting apparatus of the present embodiment includes a control unit. An exemplary control unit will be described below. The control unit may include a computer including a CPU and a memory device. FIG. 2 is a block diagram of functions of the liquid-ejecting apparatus. In the embodiment shown in FIG. 2, the liquid-ejecting apparatus is controlled by a control unit 60.

The control unit 60 receives signals from an input device and controls the operations of the liquid container 10, the ejecting head 40, the carriage 50A, and a suction device 80. More specifically, the control unit 60 causes below-described devices to cooperate with each other or controls the sequence of their operations, according to the received signal. The input device with which a command is given to the control unit 60 may be an operational button that the body of the liquid-ejecting apparatus is provided with, or a personal computer connected to the liquid-ejecting apparatus. An operator operates the input device to transmit an input signal to the control unit 60. The operator may input various commands such as those for maintenance and ejection, as described below.

The control unit 60 may include a command identification device 110. The command identification device 110 determines what command the control unit 60 has received, and the control unit 60 causes a corresponding device to operate according to the command.

The control unit 60 may include a liquid supply controller 120. When the liquid has been consumed by the replacement operation or the ejection operation, the liquid supply controller 120 causes the liquid to be supplied to the first tube 30 from the liquid container 10, and controls the timing of liquid supply and the amount of the liquid to be supplied.

The control unit 60 may include a liquid ejection controller 130. On receiving an ejection command, the liquid ejection controller 130 determines the timing of liquid ejection and the amount of the liquid to be ejected, according to the ejection data, and causes the ejecting head 40 to eject the liquid.

The control unit 60 includes a first operation controller 140. On receiving a maintenance command, an ejection command or the like, the first operation controller 140 controls the amount of the liquid to be replaced in the vessel 20 by operating the suction device 80 to eject the liquid in the vessel 20 from the head 40. In the present embodiment, the first operation may be referred to as a replacement operation.

The control unit 60 includes a second operation controller 150. On receiving a maintenance command or an ejection command, the second operation controller 150 reciprocally moves the carriage 50A in a predetermined direction MSD and controls the speed and number of the transfer operations of the carriage 50A. As the carriage 50A reciprocally moves in a predetermined direction, the agitation member 15 also transfers within the vessel 20 together with the carriage 50A. Thus, the liquid in the vessel 20 is agitated. In the present embodiment, the second operation may be referred to as an agitation operation. In the present embodiment, since the vessel 20 is mounted on the carriage 50A, the interior of the vessel 20 is agitated simultaneously with the ejection operation described below. However, the agitation operation does not include the agitation in the vessel 20 accompanying the ejection operation.

The control unit 60 includes a third operation controller 160. On receiving an ejection command, the third operation controller 160 transfers the carriage 50A in the longitudinal direction MSD according to the ejection data. The control unit 60 causes the third operation controller 160 and the ejection controller 130 to cooperate with each other so that an image is formed on an ejection target medium according to the ejection data. In the present embodiment, the third operation may be referred to as an ejection operation.

The control unit 60 may include a timing device 170. The timing device 170 stores time data, and any device having such a function can be used. For example, a timer may be used. Preferably, the timing device 170 can store time even if the liquid-ejecting apparatus is in the power-off state. For example, a rechargeable battery may be incorporated in the timing device. The timing device 170 may be able to reset the start point of timing or the accumulated time.

However, the timing device 170 does not necessarily include a resettable timer. For example, the timing device 170 may be of such a type that includes a gear for rotation therein and measures elapsed time by counting the number of rotations of the gear and correlating the number of rotations and the elapsed time. The timing device may be of a type having a mechanical structure. Alternatively, the timing device may be of a type that stores the total accumulated time. In this type, the accumulated time of the previous operations is stored, and the elapsed time t is obtained by calculating the difference between the accumulated time of the previous operations and the accumulated time until the next operation.

The control unit 60 may include a storage device 180. The storage device 180 functions as memory to store various types of information. For example, the storage device 180 can store a predetermined time (described later), or can read the accumulated time measured by the timing device 170 and store it. Also, the storage device 180 can store a predetermined first threshold time (Time T1) and second threshold time (Time T2). In this instance, Time T1 is a time until the liquid enters a state where the replacement operation is required before the ejection operation and the agitation operation, such as the time taken for a component of the liquid in the first tube 30 to settle, the time taken for a component of the liquid in the vessel 20 to settle, or the time taken for both to settle. Preferably, Time T1 is the time taken for the sediment component of the liquid to settle completely in the vessel 20 and the first tube 30, from the viewpoint of avoiding the replacement of components that do not settle.

Time T2 is set on the basis of the time until the liquid enters a state where the agitation operation is required before the ejection operation, and is shorter than Time T1.

An evaluation device 190 evaluates whether or not the elapsed time t measured by the timing device 170 is more than Times T1 and T2. The control unit 60 is configured so as to conduct a predetermined operation according to the result of the evaluation. The evaluation device 190 need not evaluate whether the elapsed time t is more than both Times T1 and T2, and may evaluate the elapsed time t only with respect to Time T1.

### 1. 7. Flow of Control

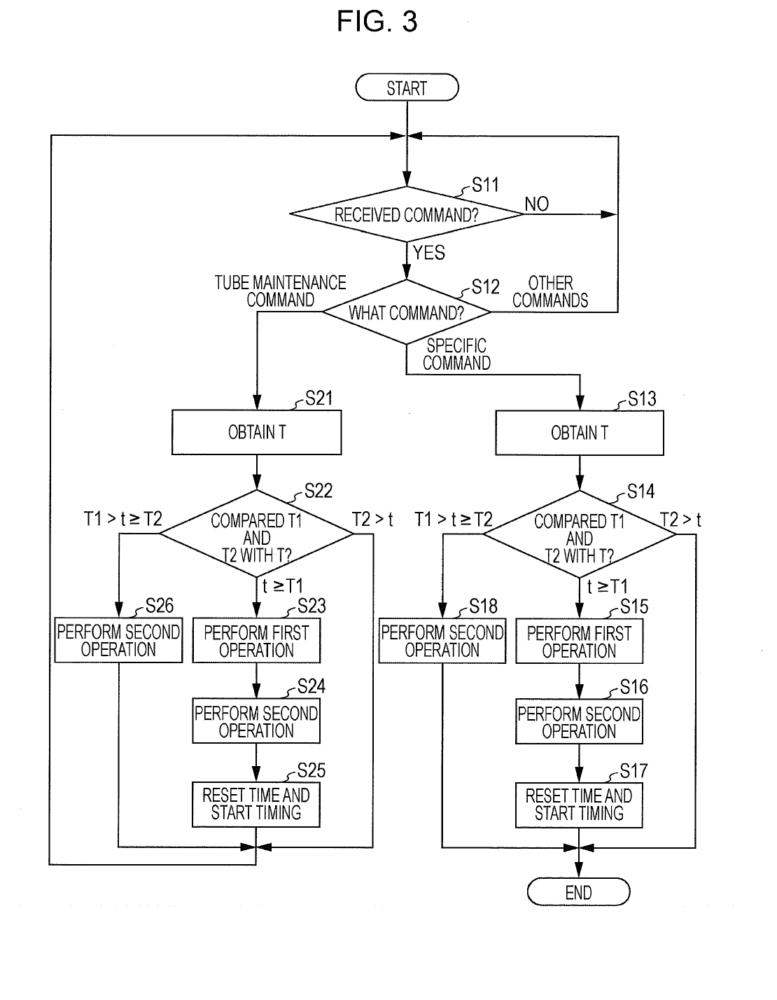

FIG. 3 is a flowchart of the control of the liquid-ejecting apparatus of the present embodiment. How the control is conducted in the liquid-ejecting apparatus will be described with reference to the flowchart shown in FIG. 3.

### (1) Elapsed Time Evaluation

The control unit 60 first determines whether it has received an input signal from the input device (Step S11). When the control unit 60 cannot receive an input signal (in the case of N in Step S11), the liquid-ejecting apparatus enters a stand-by state until a signal is received. When the control unit 60 has received a signal from the input device (in the case of Y in step S11), the command identification device 110 determines whether the signal is a specific command or a command for maintenance of the interior of the tube (Step S12). If it is not either (if it is another command), the apparatus operates according to the command as usual and then enters the standby state.

In this flow of the control, the elapsed time t refers to the time period from the last completion of any of the replacement operation, the agitation operation after the replacement operation, and the ejection operation, until the command identification device 110 identifies the command transmitted from the operator through the input device as the specific command. The specific command can be any command except the maintenance command. For example, it may be a predetermined command to the control unit 60 to perform the replacement operation, to perform the replacement operation and then the agitation operation, to perform the ejection operation, to turn on the power if the liquid-ejecting apparatus is in the power-off state, or to turn off the power of the running liquid-ejecting apparatus.

When the command identification device 110 identifies a specific command (for example, ejection command), the control unit 60 reads the elapsed time t from the storage device 180 (Step S13).

Subsequently, the control unit 60 compares the elapsed time t with Times T1 and T2 previously stored in the storage device 180 (Step S14). If the elapsed time t is equal to or more than Time T1, the first operation controller 140 causes the first operation to be performed (Step S15). Thus, the liquid in which sediment has settled in the first tube 30 can be replaced with a liquid having a proper concentration.

In the first operation, the amount of liquid in the vessel 20 to be replaced is preferably in the range of 0.4 to 1.0 times the capacity of the first tube 30, and more preferably in the range of 0.8 to 1.0 times.

After the completion of the first operation, the second operation controller 150 causes the second operation to be performed (Step S16). The second operation reciprocally transfers the carriage 50A in a predetermined direction MSD. Thus, the liquid in the vessel 20 is sufficiently agitated to a proper concentration. Since the first operation has been performed and the liquid in the first tube 30 has been replaced with proper liquid, the elapsed time t is reset (Step S17) after the first operation. Thus, the sequence of operations for evaluating whether the elapsed time t is equal to or more than Time T1 is completed, and the liquid-ejecting apparatus performs an operation according to the command input subsequently.

For example, if the subsequent command is the ejection command (command to perform the third operation), the third operation controller 160 causes the third operation to be performed according to ejection data after Step S17. The control unit 60 controls the third operation controller 160 so as to cooperate with the liquid ejection controller 130. Thus, the liquid ejection controller 130 and the third operation controller 160 control the amount of liquid to be ejected from the head 40, the ejection timing, the transfer of the carriage 50A in a predetermined direction MSD, so that the liquid can be ejected onto an ejection target medium according to desired data. In the third operation in the present embodiment, the carriage 50A is reciprocally transferred in a predetermined direction MSD. Consequently, the liquid in the vessel 20 can be agitated. Since the liquid in the tube is replaced by the third operation, it is preferable to reset the elapsed time t.

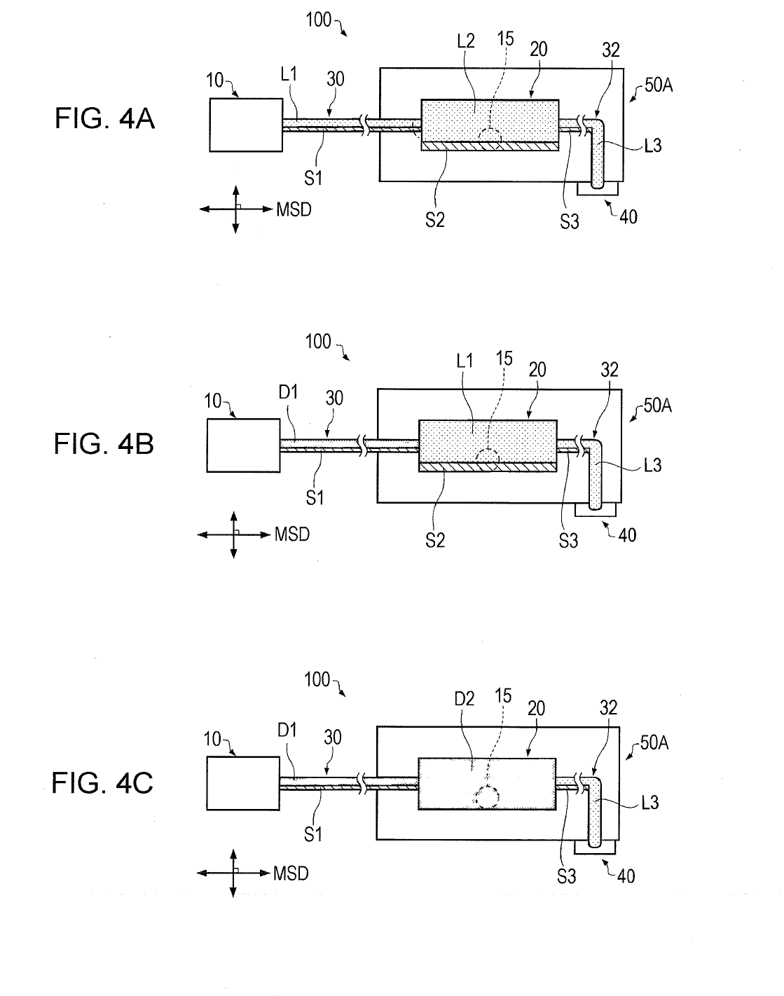

Step S16 that performs the second operation after the first operation when the elapsed time t is equal to or more than Time T1 will now be described in detail with reference to FIGS. 4A to 4C. FIGS. 4A to 4C are schematic representations of states of sediment in the liquid-ejecting apparatus. FIG. 4A is a schematic side view of the liquid-ejecting apparatus after Time T1 has elapsed.

After the elapsed time t exceeds Time T1, the liquid in the first tube 30 is separated into sediment S1 and supernatant L1, the liquid in the vessel 20 is separated into sediment S2 and supernatant L2, and the liquid in the second tube 32 is separated into sediment S3 and supernatant L3, as shown in FIG. 4A. If the liquid supply to the head 40 is started in this state, the supernatants L1, L2 and L3 are delivered to the head 40. Consequently, the liquid ejected from the head 40 has large variations in composition.

If the supernatant L2 and sediment S2 are sufficiently agitated after Time T1 has been elapsed and, then, the liquid is supplied to the head 40, the head 40 can receive sufficiently mixed and agitated liquid. However, the supernatant L1 and sediment S1 in the first tube 30 are hardly agitated. Consequently, only the supernatant L1 is delivered to the vessel 20, but the sediment S1 is hardly delivered. Hence, if the liquid in the vessel 20 is supplied to the head 40, the supernatant L1 delivered to the vessel 20 is undesirably supplied to the second tube 32 and finally ejected from the head 40.

Accordingly, when the elapsed time t is equal to or more than the first threshold time T1, the first operation is performed to discharge the supernatant L2 in the vessel 20 and part of the liquid in the vessel 20 is replaced with the supernatant L1. Subsequently, liquid D1 is delivered from the container 10 to the first tube 30, as shown in FIG. 4B. Then, the vessel 20 is filled with the liquid D2 prepared by sufficiently mixing and agitating the supernatant L1 and the sediment S2 in the vessel 20, as shown in FIG. 4C, by the second operation. The ejecting head 40 can receive the liquid D2 and liquid D1 having a constant, uniform composition.

In this instance, if the second operation is performed before the first operation, the liquid in the vessel 20, which has a proper concentration and contains necessary components, is undesirably replaced with the supernatant L1 in the first tube 30, and thus the concentration of the liquid in the vessel 20 is reduced. It is therefore preferable that the first operation be performed before the second operation.

If the elapsed time t is less than Time T1 and equal to or more than Time T2 in Step S14, the second operation controller 150 causes the second operation to be performed without performing the first operation (S18). Thus, the evaluation of whether the elapsed time t is less than Time T1 and equal to or more than Time T2 is completed, and the liquid-ejecting apparatus performs an operation according to the command input subsequently.

Time T2 represents the time for the sediment component of the liquid to settle in the vessel 20 and the first tube 30. More specifically, Time T2 represents the time period from the time the liquid supply from the container 10 to the first tube 30 is started until the apparatus enters a state where the concentration of the liquid supplied to the head 40 is considerably reduced unless the liquid in the vessel 20 is sufficiently agitated though the concentration of the liquid delivered to the vessel 20 from the tube is a certain level. Time T2 can be set according to the specific gravity or the content of the sediment component of the liquid and can be previously stored in the storage device 180.

When the elapsed time t is less than Time T1 and equal to or more than Time T2, a liquid having a uniform composition can be supplied to the head 40 by the second operation even though the liquid in the vessel 20 is not replaced.

On the other hand, when the elapsed time t is less than Time T2 in Step S14, the first operation and the second operation are not performed. Thus, the evaluation of whether the elapsed time t is less than Time T2 is completed, and the liquid-ejecting apparatus performs an operation according to the command input subsequently. Since sediment is hardly present in the first tube 30 and the vessel 20, a liquid having a uniform composition can be supplied to the head 40 even though the first operation and the second operation are not performed. Since the liquid in the first tube 30 is not replaced in these cases, the elapsed time t is not reset.

When the elapsed time t is equal to or more than Time T1, the second operation is performed after the first operation. However, since the first tube 30 is replaced with a proper liquid by the first operation, the first operation is not necessarily followed by the second operation. Although the elapsed time t is evaluated in the present embodiment, the first operation or the first and second operations may be automatically performed without evaluating the elapsed time t accompanying a specific operation.

Preferably, if the second operation is performed, the first operation is repeated after the second operation. Thus, the thin liquid in the second tube and the ejecting head 40, where agitation or replacement has not been performed, can be replaced with a thick liquid. Since the liquid in the first tube 30 is replaced with a proper liquid by the third operation as well, it is preferable to reset the elapsed time t after the third operation.

If the specific command in the evaluation of the elapsed time t is the ejection command for ejecting the liquid to an ejection target medium according to ejection data (command for performing the third operation), the third operation controller 160 causes the third operation to be performed after the completion of the second operation. It is the most advantageous that the specific command is the ejection command (for performing the third operation) because the third operation can be performed with the interior of the first tube 30 kept in good condition.

### (2) Execution of Tube Maintenance Command

The flow of the operations performed when the command identification device 110 (Step S12) identifies the command input by the operator using the input device as the command for maintaining the interior of the tube (hereinafter simply referred to as maintenance command) will now be described with reference to FIG. 3. In the execution of a maintenance command, the evaluation of the elapsed time is triggered by the command input by the operator, unlike the case of (1) elapsed time evaluation performed accompanying a command (specific command) for performing a specific operation. In this flow of operations, Steps S21 to S26 are performed in the same manner as Steps S13 to S18, and the same description is omitted. In this flow, the first operation may perform ejection onto an ejection target medium. Thus, the interiors of the first tube 30 and the vessel 20 can be kept in good condition by the intention of the operator.

In the flow of the operations for evaluating the elapsed time including Step S13 shown in FIG. 3, the elapsed time t is obtained and is compared with Time T1 and Time T2. It is thus determined whether the second operation is performed after or without performing the first operation, depending on the result of the comparison. However, the controls of the liquid-ejecting apparatus are not limited to the flow shown in FIG. 3. For example, when the ejection command or the maintenance command is received, the elapsed time t may exceed Time T2, and it may be determined that the second operation will be performed. In such a case, the second operation may be performed following the first operation, irrespective of Time T1. Alternatively, on receiving the ejection command or the maintenance command, the first operation and subsequently the second operation may be performed irrespective of Times T1 and T2. Preferably, the first operation is repeated after the second operation, as described above.

### (3) Other Flows

Another flow of operations will be described below. In this flow, the elapsed time t refers to the time measured after the last completion of any one of the replacement operation, the agitation operation after the replacement operation, and the ejection operation. Also, this flow of operations is different from the flow for elapsed time evaluation in that the first operation starts automatically when the elapsed time t exceeds Time T1. In this instance, two storage devices 180 are provided. One is intended to measure Time T1 (hereinafter referred to as first storage device), and the other is intended to measure Time T2 (hereinafter referred to as second storage device). When the elapsed time t of the second storage device exceeds Time T2, the second operation is automatically performed. When the elapsed time t of the first storage device exceeds Time T1, the first operation is automatically performed. The first operation and the second operation may be performed at one time. If a specific operation is performed for a time more than Times T1 and T2, preferably, both the first storage device and the second storage device are reset.

In the liquid-ejecting apparatus in an off state, if the elapsed time t of the first storage device exceeds Time T1 or if the elapsed time t of the second storage device exceeds Time T2, the control unit 60 may allow the liquid-ejecting apparatus to turn on automatically so that a specific operation can be performed. If the operator turns on the liquid-ejecting apparatus, a specific operation may be automatically performed. In either case, the liquid in the first tube 30 can be rapidly replaced with liquid having a proper concentration. When the elapsed time t of the first storage device exceeds Time T1, the second operation may be performed after the first operation and, then, the first operation is repeated again to replace the liquid in the second tube 32, as in the flow for (1) Elapsed Time Evaluation. Other operations are the same as in the flow for (1) Elapsed Time Evaluation, and thus description thereof is omitted.

### 2. LIQUID-EJECTING APPARATUS

The liquid-ejecting apparatus of the present embodiment includes the liquid agitation unit 100 described above. In the present embodiment, the liquid-ejecting apparatus 300 including the liquid agitation unit 100 will be described using an ink jet printer, and the liquid-ejecting apparatus 300 is hereinafter referred to as the ink jet printer 300.

FIG. 5 is a perspective view of the ink jet printer 300 including the liquid agitation unit 100. The ink jet printer 300 of the present embodiment includes a control section 360, a container 10, a liquid supply tube 30, a driving section 50, and a transport section 70, as shown in FIG. 5.

The driving section 50 includes a carriage 50A, a driving belt 50B, and a carriage motor 50C. The driving section 50 is connected to the control section 360 with a flexible cable 62 so as to be controlled by the control section 360. The driving section 50 reciprocally moves the carriage 50A on which an ejecting head 40 (not shown) is mounted. More specifically, the carriage motor 50C, which is the driving source of the carriage 50A, drives the driving belt 50B connected to the carriage 50A to move the carriage 50A reciprocally.

The ejection target medium P is transported by the transport section 70, and onto which the ejecting head 40 on the carriage 50A ejects a liquid delivered from the container 10 during the transport. Then, the ejection target medium P is ejected to the outside of the apparatus.

The liquid-ejecting apparatus of the embodiments of the invention can be used as color material ejecting apparatuses used for manufacturing color filters of liquid crystal displays, liquid material ejecting apparatuses used for forming electrodes and color filters of organic EL displays, field emission displays (FEDs) and electrophoretic displays, and bioorganic material ejecting apparatus used for manufacturing bio-chips, in addition to the ink jet printer 300 described above as an example of the liquid-ejecting apparatus.

### 3. EXAMPLES

The invention will be further described with reference to specific Examples. However, it is not limited to the Examples.

### 3. 1. Preparation of White Ink Composition

A white ink composition containing the following constituents was prepared.

Titanium dioxide (average particle size: 360 nm, specific gravity: 4.3): 10% by mass

Styrene-acrylic acid copolymer: 2% by mass

1,2-Hexanediol: 5% by mass

Glycerol: 10% by mass

Triethanolamine: 0.9% by mass

BYK-348 (produced by BYK): 0.5% by mass

Ultrapure water: balance

Total: 100% by mass

### 3. 2. Apparatus

For preparing test samples for evaluation, an ink jet printer EPSON PX-G930 (manufactured by Seiko Epson) was modified into the structure shown in FIG. 5. More specifically, a vessel was mounted on the carriage of the ink jet printer in such a manner that the longitudinal direction of the vessel is parallel to the moving direction of the carriage, and the container and the vessel were connected to each other with a first tube. Also, the vessel was connected to the head with a second tube. The vessel was charged with the white ink composition prepared in the above “3. 1. Preparation of White Ink Composition”.

The vessel was in a cylindrical shape (capacity: 20 mL). A spherical agitation member (diameter: 1.0 cm, specific gravity: 7.9) was placed in the vessel. The first tube had a capacity of 20 mL.

### 3. 3. Preparation of Test Samples

### Example 1

After the ink jet printer was started, the white ink composition was delivered from the container to fill the first tube and the vessel, and further the second tube and the head, with the white ink composition. The ink jet printer was allowed to stand for 30 days to settle the titanium oxide contained in the white ink composition in the first tube and the vessel.

Then, 20 mL of liquid in the vessel was discharged through the head and the white ink composition was supplied to the first tube from the container. Thus, the supernatant in the first tube was delivered to the vessel (replacement operation). Subsequently, the carriage was reciprocally moved a length of 23 cm at a speed of 46 cm/s 30 times (agitation). Then, 2 mL of liquid in the second tube and head was removed by flushing, and the liquid in the container was ejected through the head while being supplied from the container to the head through the first tube and the vessel (ejection operation). At this time, the liquid ejected from the head was collected 4 mL each in sample bottles to prepare test samples of Example 1.

### Example 2

Test samples of Example 2 were prepared in the same manner as in Example 1, except that 16 mL of liquid was discharged in the replacement operation.

### Example 3

The titanium oxide in the white ink composition was settled in the first tube and the vessel in the same manner as in Example 1. Then, an initial operation was performed (initial operation). The initial operation reciprocally moved the carriage along a length of 28 cm at a speed of 70 cm/s twice. Subsequently, 20 mL of liquid was discharged from the head. Then, test samples were collected in the same manner as in Example 1.

### Example 4

Test samples of Example 4 were prepared in the same manner as in Example 1, except that 8 mL of liquid was discharged in the replacement operation.

### Comparative Example 1

The titanium oxide in the white ink composition was settled in the first tube and the vessel in the same manner as in Example 1. Subsequently, the carriage was reciprocally moved a length of 23 cm at a speed of 46 cm/s 30 times (agitation). Then, 2 mL of liquid in the second tube and head was removed by flushing, and the liquid in the container was ejected through the head while being supplied from the container to the head through the first tube and the vessel (ejection).

At this time, 0.8 mL of the liquid ejected first from the head was collected in a sample bottle, and subsequently 3.2 mL of the liquid ejected was collected in another sample bottle. Then, the liquid hereinafter ejected from the head was collected 4 mL each in other sample bottles. Test samples of Comparative Example 1 were thus prepared.

### Comparative Example 2

The titanium oxide in the white ink composition was settled in the first tube and the vessel in the same manner as in Example 1. Then, before the ejection operation, the carriage was reciprocally moved a length of 23 cm at a speed of 46 cm/s 30 times (agitation). Then, 20 mL of liquid in the vessel was discharged through the head, and subsequently 2 mL of liquid in the second tube and head was removed by flushing. Then, the white ink composition was supplied to the first tube from the container, so that the supernatant in the first tube was delivered to the vessel (replacement). Then, the liquid was ejected from the head while being supplied from the container to the head through the first tube and the vessel (ejection). At this time, the liquid ejected from the head was collected 4 mL each in sample bottles to prepare test samples of Comparative Example 2.

### 3. 4. Evaluation Test

The titanium dioxide concentrations in the test samples of Examples 1 to 4 and Comparative Examples 1 and 2 prepared above were measured with a spectrophotometer U-3300 (manufactured by Hitachi).

### 3. 5. Evaluation Results

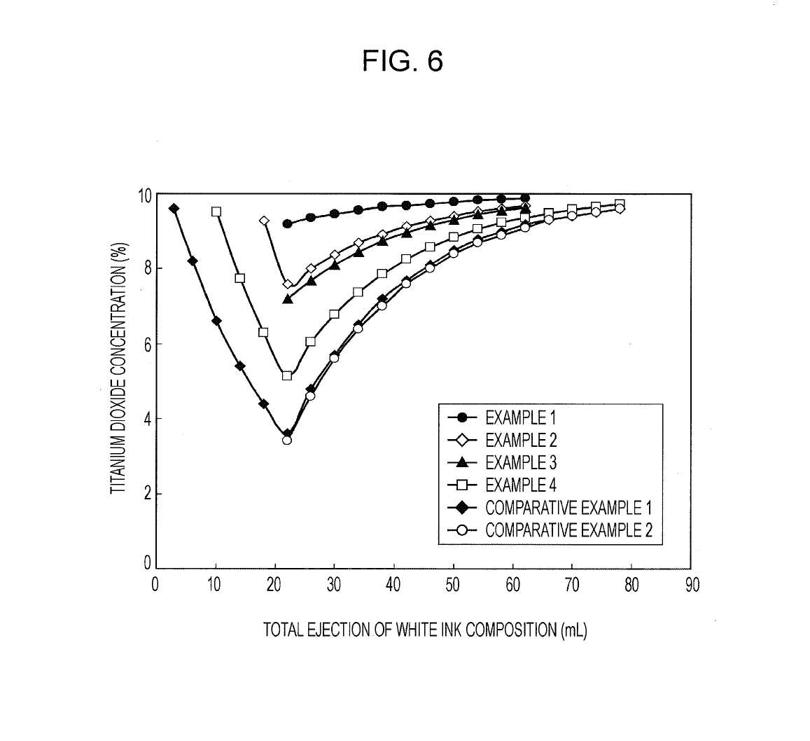

The results of the evaluation are shown in FIG. 6. In FIG. 6, the horizontal axis represents the total amount (mL) of the white ink composition ejected from the head. The vertical axis represents the titanium dioxide concentration (% by mass) in each volume of the white ink composition ejected.

Examples 1 to 4 were controlled so as to perform the agitation operation after the replacement operation. Accordingly, these examples showed that the decrease in titanium dioxide concentration had been small since the early stage of the ejection operation, as shown in FIG. 6. Also, it was shown that even when the ejection of the white ink composition was continued, the titanium dioxide concentration was recovered effectively. In Example 1, the titanium dioxide concentration was 9.2% reduced. In Example 2, when the titanium dioxide concentration was reduced, it was 7.58%. In Example 3, when the titanium dioxide concentration was reduced, it was 6.9%. In Example 4, when the titanium dioxide concentration was reduced, it was 5.1%.

On the other hand, Comparative Example 1 was controlled so as to perform the ejection operation after the agitation operation without performing the replacement operation. Accordingly, the titanium dioxide concentration had been rapidly reduced since the early stage of the ejection operation, as shown in FIG. 6. Also, a large amount of white ink composition was required in order to recover the titanium dioxide concentration to the same level as in Examples. In Comparative Example 1, when the titanium dioxide concentration was reduced, it was 3.6%.

The titanium dioxide concentration in Comparative Example 1 will now be concretely described. When the ejection of the white ink composition is started from the head, the supernatant in the first tube is delivered to the vessel, and the liquid in the vessel is agitated accompanying the movement of the head. Consequently, the concentration in the vessel is reduced to lower than a proper concentration. This liquid is then supplied to the head. Thus, the decrease in titanium dioxide concentration of the liquid ejected from the head is started as shown in FIG. 6. When all the supernatant in the first tube is supplied to the head, the concentration of the titanium dioxide in the white ink composition ejected from the head is reduced to 3.6%. Accordingly, it is required that a large amount of white ink composition be supplied to increase the titanium dioxide concentration in the white ink composition.

Comparative Example 2 was controlled so as to perform the replacement operation after the agitation operation. Consequently, the necessary components in the vessel were discharged with the liquid, and at the same time, the supernatant in the first tube was supplied. Thus, significant decrease in titanium dioxide concentration was observed from the early stage of the ejection operation, as shown in FIG. 6. Thus, it was shown that a large amount of white ink composition was needed to increase the titanium dioxide concentration of the white ink composition. In Comparative Example 2, when the titanium dioxide concentration was reduced, it was 3.4%.

From the results of the above evaluation, it has been shown that the amount of liquid to be discharged by the replacement operation is preferably 0.4 times or more and less than 1.0 times the capacity of the first tube, and more preferably in the range of 0.8 times or more and less than 1.0 times. The reason why an amount of less than 1.0 times is preferred is that if the entirety in the first tube is completely replaced by the replacement operation, the significance of the agitation unit is lost which recovers (equalizes) the concentration of the liquid by agitation in the vessel connected to the first tube.

The invention is not limited to the above-described embodiments, and various modifications may be made. For example, the invention includes substantially the same form as the disclosed embodiments (for example, a form including the same function and method and producing the same result, or a form having the same intent and producing the same effect). Some elements unessential to the form of the disclosed embodiment may be replaced. The form of an embodiment of the invention includes an element producing the same effect or achieving the same object, as the form of the disclosed embodiments. The forms of the disclosed embodiments may be combined with the known art.

What is claimed is:

1. A liquid-ejecting apparatus comprising:
a liquid container that contains a liquid containing a substance that can settle;
a vessel connected to the liquid container with a tube, the vessel receiving the liquid from the liquid container;
an ejecting head connected to the vessel, the ejecting head receiving the liquid from the vessel and ejecting the liquid;
an agitation unit that agitates the liquid in the vessel; and
a control unit that controls a first operation that ejects the liquid from the ejecting head and a second operation that agitates the liquid with the agitation unit after the first operation.

2. A liquid-ejecting apparatus comprising:
a liquid container that contains a liquid containing a substance that can settle;
a vessel connected to the liquid container with a tube, the vessel receiving the liquid from the liquid container;
an ejecting head connected to the vessel, the ejecting head receiving the liquid from the vessel and ejecting the liquid to an ejection target medium;
an agitation unit that agitates the liquid in the vessel;
a control unit that controls a first operation that ejects the liquid from the ejecting head to something other than the ejection target medium, a second operation that agitates the liquid in the vessel with the agitation unit, and a third operation that ejects the liquid to the ejection target medium; and
an evaluation device that evaluates whether or not the elapsed time after the completion of any of the first operation, the second operation after the first operation, and the third operation is equal to or more than a first threshold time,
wherein when the elapsed time is equal to or more than the first threshold time, the control unit causes the first operation to be performed.

3. A liquid-ejecting apparatus comprising:
a liquid container that contains a liquid containing a substance that can settle;
a vessel connected to the liquid container with a tube, the vessel receiving the liquid from the liquid container;
an ejecting head connected to the vessel, the ejecting head receiving the liquid from the vessel and ejecting the liquid to an ejection target medium;
an agitation unit that agitates the liquid in the vessel;
a control unit that controls a first operation that ejects the liquid from the ejecting head to something other than the ejection target medium, a second operation that agitates the liquid in the vessel with the agitation unit, and a third operation that ejects the liquid to the ejection target medium;
an input device with which an operator inputs a specific command to the liquid-ejecting apparatus; and
an evaluation device that evaluates whether or not the elapsed time from the completion of any of the first operation, the second operation after the first operation, and the third operation until the specific command is inputted with the input device is equal to or more than a first threshold time,
wherein when the elapsed time is equal to or more than the first threshold time, the control unit causes the first operation to be performed.

4. The liquid-ejecting apparatus according to claim 2, wherein when the elapsed time is equal to or more than the first threshold time, the control unit causes the second operation to be further performed after the first operation.

5. The liquid-ejecting apparatus according to claim 3, wherein when the elapsed time is equal to or more than the first threshold time, the control unit causes the second operation to be performed after the first operation.

6. The liquid-ejecting apparatus according to claim 1, wherein the control unit causes the first operation to be performed again after the second operation.

7. The liquid-ejecting apparatus according to claim 2, wherein when the elapsed time is equal to or more than the first threshold time, the control unit causes the second operation to be performed after the first operation, and then the first operation to be performed again.

8. The liquid-ejecting apparatus according to claim 3, wherein when the elapsed time is equal to or more than the first threshold time, the control unit causes the second operation to be performed after the first operation, and then the first operation to be performed again.

9. The liquid-ejecting apparatus according to claim 3, wherein the evaluation device determines whether or not the elapsed time is equal to or more than a second threshold time longer than the first threshold time, and less than the first threshold time, and when the elapsed time is equal to or more than the second threshold time and less than the first threshold time, the control unit causes the second operation to be performed.

10. The liquid-ejecting apparatus according to claim 2, wherein the first threshold time is a time equal to or more than the time needed for the substance that can settle to settle completely in the vessel and the tube.

11. The liquid-ejecting apparatus according to claim 3, wherein the first threshold time is a time equal to or more than the time needed for the substance that can settle to settle completely in the vessel and the tube.

12. The liquid-ejecting apparatus according to claim 2, wherein the control unit causes the third operation to be performed during the second operation, and when the elapsed time is equal to or more than the first threshold time, the amount of liquid ejected in the first operation is 0.4 times or more and less than 1.0 times the capacity of the tube.

13. The liquid-ejecting apparatus according to claim 3, wherein the control unit causes the third operation to be performed during the second operation, and when the elapsed time is equal to or more than the first threshold time, the amount of liquid ejected in the first operation is 0.4 times or more and less than 1.0 times the capacity of the tube.
